(19) United States
(12) Patent Application Publication
(10) Pub. No.: US 2011/0198442 A1
(43) Pub. Date: Aug. 18, 2011

(54) Workstation for Integration in an Aircraft, in Particular a Helicopter

(76) Inventors: Dieter John, Miesbach (DE); Gerhard Wenger, Planegg (DE)

(21) Appl. No.: 12/680,067

(22) PCT Filed: Sep. 25, 2008
(86) PCT No.: PCT/EP2008/008150

§ 371 Date: Sep. 10, 2010

(30) Foreign Application Priority Data
Sep. 25, 2007 (DE) 10 2007 045 731.8

(51) Int. Cl. B64D 11/00

(52) U.S. Cl. 244/118.5

(57) ABSTRACT

A workstation for integration in an aircraft, in particular a helicopter, comprises a floor anchoring area (14) for anchoring the workstation (10) on an aircraft floor, a first mounting area (18) which is essentially fixed on the floor anchoring area (14), a second mounting area (36) which is supported on the first mounting area (18) such that it can pivot, a monitor unit (60) which is mounted on the second mounting area (36) such that it can pivot, and a manual control unit (82) which is mounted on the first or the second mounting area (18; 36) such that it can pivot.

The present invention pertains to a workstation for integration in an aircraft such as a helicopter.

Such a workstation is known from WO 2005/025986 A1. With this known workstation, a monitor unit is supported by a box-like mounting surrounding a seat for the operator in such a way that it can be brought into a working position and into a stowage position. In the stowage position, the monitor unit is accommodated in an armrest area so that the operator has free access to the seat. An operating assembly of a manual control unit is provided in another armrest area, with which a person taking a place in such a seat can operate various auxiliary equipment, such as spotlights, a monitoring camera or the like.

It is the object of the present invention to provide a workstation for integration in an aircraft, in particular a helicopter, which offers high functionality and adaptability, particularly to different operators, yet requires little space for installation and in particular is consequently especially suited for retrofitting in the interior space of aircraft of this type.

This object is met according to the invention by a workstation for integration in an aircraft, in particular a helicopter, comprising a floor anchoring area for anchoring the workstation to an aircraft floor, a first mounting area which is essentially fixed on the floor anchoring area, a second mounting area which is supported on the first mounting area such that it can pivot, a monitor unit which is mounted on the second mounting area such that it can pivot as well as a manual control unit mounted on the first mounting area such that it can pivot.

By subdivision into different assemblies mounted on one another such that they can pivot, it is possible on one hand to position these in such a way that they are easily accessible for an operator and/or are also visually perceptible. On the other hand, this workstation with its various units can be very easily brought into a stowage position in which it not only requires very little installation space and consequently then also gives an operator the option to take an aircraft seat provided in the area of the workstation and/or also in an emergency to move out of this seat again.

In order to be able to move the monitor unit closer to an operator or also to be able to remove it again, it is proposed that the second mounting area is pivotable on the first mounting area about a first pivoting axis essentially parallel to the floor anchoring area. The fine adjustment of the monitor unit, relative to the set proximity, can for example then also be easily provided in that the monitor unit is pivotable on the second mounting area about a second pivoting axis essentially parallel to the floor anchoring area. The mounting area and monitor unit can preferably be pivotable about pivoting axes which are essentially parallel to one another.

If the manual control unit is also pivotable on the first mounting area about a third pivoting axis essentially parallel to the floor anchoring area, very simple adaptability to various operating situations is also achieved with regard to this manual control unit.

In particular in order to be able to avoid the risk of injuries during flight manoeuvres or undefined operating procedures, it is proposed that the second mounting area be made lockable in a plurality of pivot positions with respect to the first mounting area. This plurality of pivot positions can also include a stowage pivot position of the second mounting area.

The monitor unit can also preferably be able to be locked in a plurality of pivot positions with respect to the second mounting area, where here too this plurality of pivot positions can include a stowage pivot position of the monitor unit.

For the manual control unit as well, a stowage pivot position and at least one working pivot position are preferably provided, in which positions it is able to be locked with respect to the first mounting area, so that both in the stowed condition and in the working condition undefined and thus dangerous movements of the manual control unit can be excluded.

In order to achieve locking of the manual control unit easily, it is proposed that a stowage locking arrangement be assigned to the manual control unit, which locks it on the second mounting area in the stowage pivot position of the manual control unit.

Even finer adjustability of the workstation according to the invention, in particular for various operators, can be ensured in that the manual control unit includes a telescoping support arm which can be locked in a plurality of telescoping positions. In order to be able to specify a defined positioning for the stowed condition here as well, it is proposed that the plurality of telescoping positions include a stowage telescoping position for the manual control unit.

The manual control unit can include an operating assembly mounted on the support such that it is pivotable. For this as well the provision can be made that it is pivotable with respect to the support arm about a pivoting axis which is essentially parallel to the floor anchoring area. Defined positioning can also be provided this way for the operating assembly in that the operating assembly can be positioned with respect to the support arm in at least one stowage pivot position and one working pivot position.

To ensure for the workstation according to the invention that in the stowed condition all assemblies are in defined positions, it is preferably provided that the manual control unit can essentially only be locked on the second mounting area with the second mounting area arranged in the stowage pivot position and the manual control unit arranged in the stowage telescoping position. It can furthermore be provided here that the manual control unit can essentially only be locked on the second mounting area with the operating assembly positioned in the stowage pivot position with respect to the support arm.

The present invention will be explained in detail below with reference to the accompanying figures. Shown are in

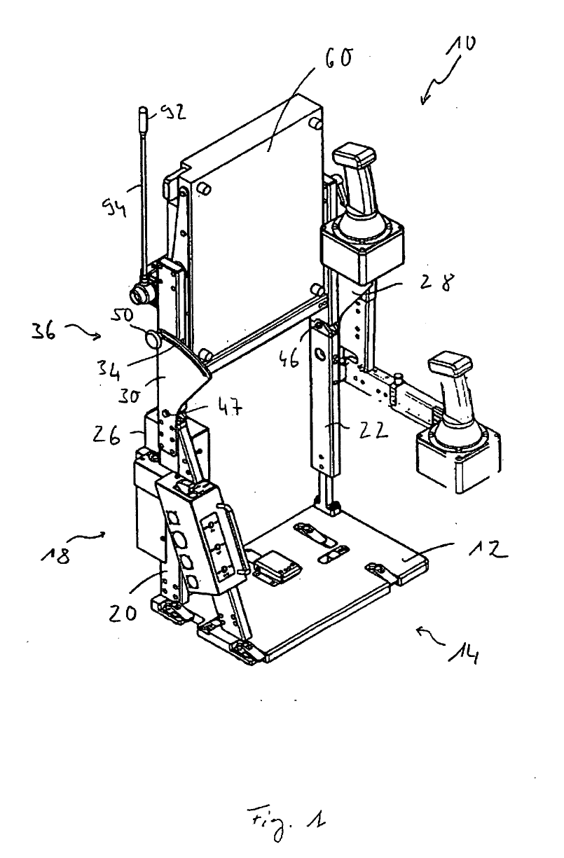

FIG. 1 a perspective view of a workstation constructed according to the invention;

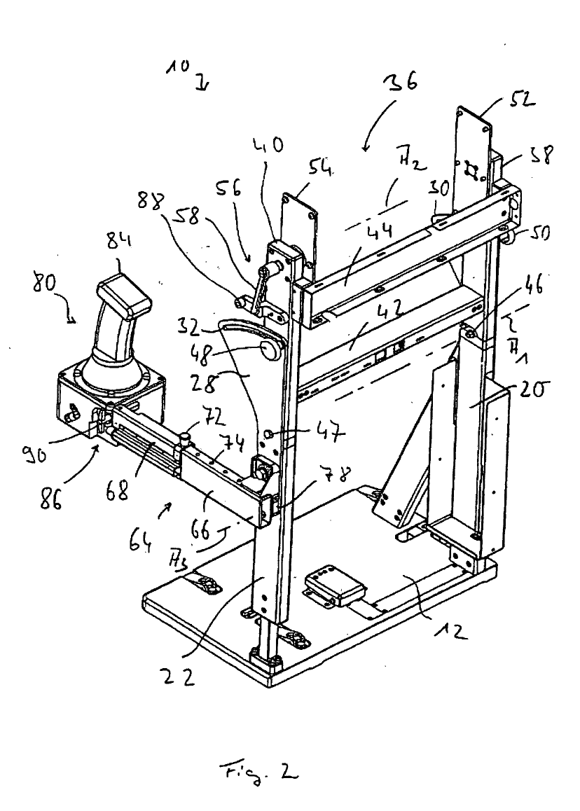

FIG. 2 another perspective representation of the workstation without monitor unit;

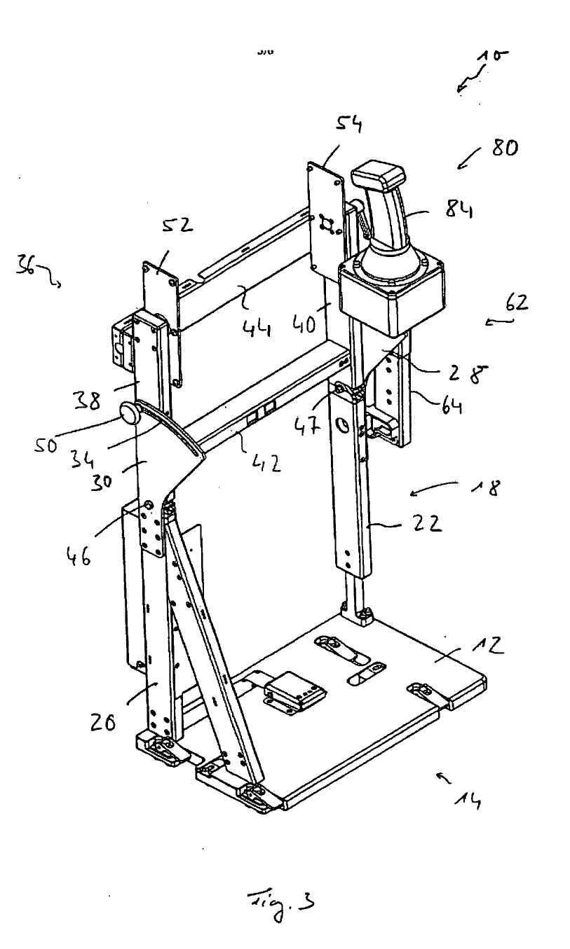

FIG. 3 another perspective representation of the workstation without monitor unit;

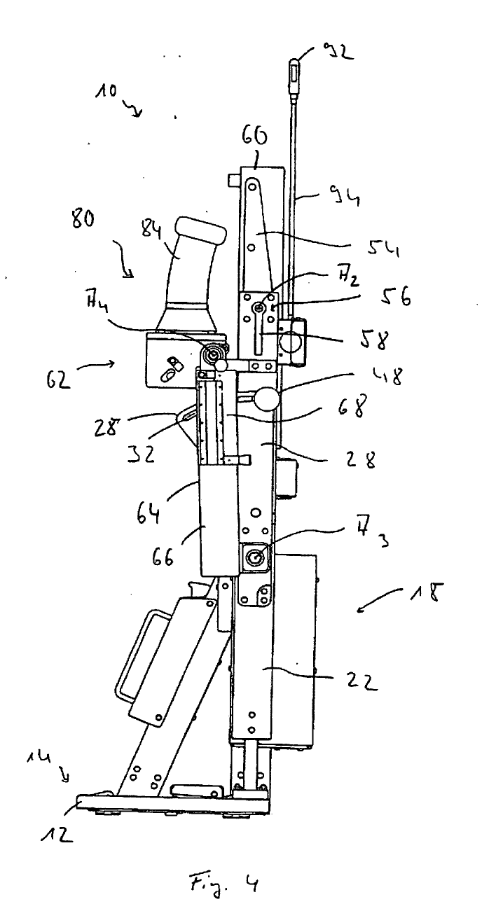

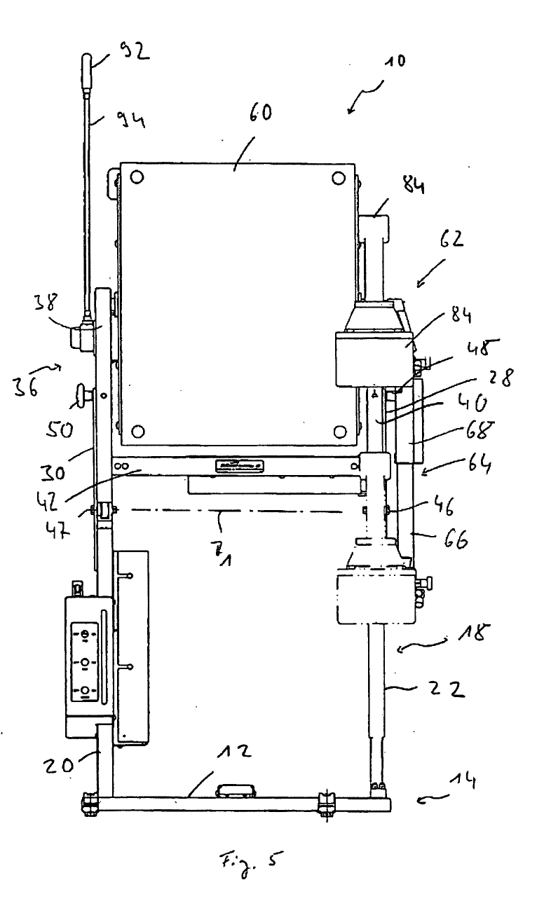

FIG. 4 a side view of the workstation shown in FIG. 1, viewed in viewing direction IV in FIG. 5;

FIG. 5 a frontal view of the workstation shown in FIG. 1, viewed in viewing direction V in FIG. 4;

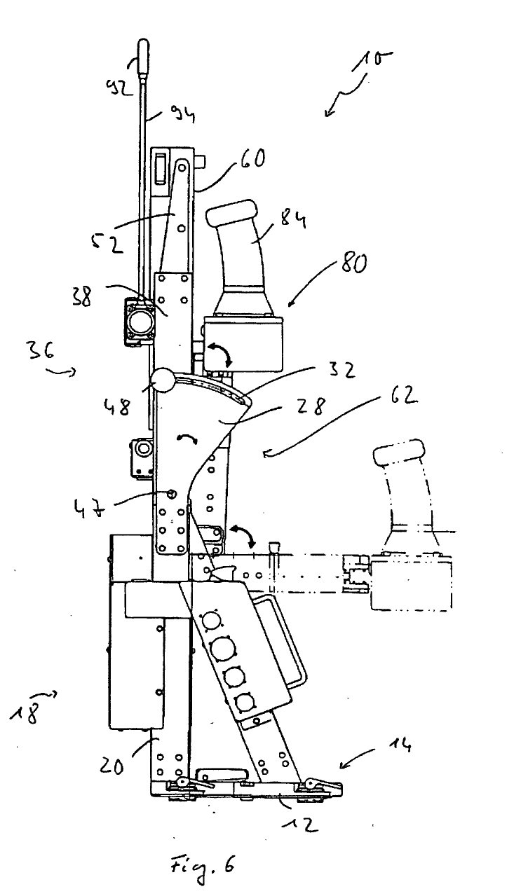

FIG. 6 a side view of the workstation shown in FIG. 1, viewed in viewing direction VI in FIG. 5.

The workstation 10 constructed according to the invention and shown in the FIGS. 1 to 6 is intended fundamentally for integration in an aircraft, in particular for integration in a helicopter. This workstation 10 is, for example, arranged behind the pilot's seat and the co-pilot's seat in an available space of a helicopter, in which an additional seat for an operator working with the workstation can also be arranged. Various accessory units provided on the helicopter, such as cameras, spotlights, possibly weapon systems or other monitoring systems can be operated by means of this workstation 10.

For fixing on the floor of an aircraft, the workstation 10 according to the invention includes a floor anchoring area 14 constructed with a floor plate 12. Various fixtures 16 are envisaged on this floor plate 12, which can be used, for example through interaction with rails on the floor of a helicopter, for fixing the entire workstation 10.

Fixed directly on the floor plate 12 is a first mounting area 18. This includes on the two lateral end areas of the floor plate 12 supports 20, 22 extending upward, essentially orthogonal to the floor plate 12, which are firmly connected to the floor plate 12 by bolting, for example. A strut 24, securely connected for example with the support 20 on one side and the floor plate 12 on the other side, provides additional stability. Furthermore, on one of the supports, such as support 20, a box-like housing 24 can be arranged for holding additional accessory parts, such as a video device or the like.

In their upper end area, the two supports 20, 22 bear securely attached pivoting lock plates 28, 30. These are formed in an approximately triangular configuration and in their upper end area, which extends beyond the supports 20, 22, have slot-like openings 32, 34 in each case.

In close proximity to the connection of the pivoting lock plates 28, 30 on the supports 20, 22 a second mounting area generally indicated with 36 is supported on the first mounting area 18 such that it can pivot. The second mounting area 36 likewise includes two supports 38, 40 arranged essentially upright, which are connected to one another by a cross-member 42 in their lower end area, that is, the area lying close to the pivoting connection on the first mounting area. The two supports 38, 40 of the second mounting area 36 are also securely connected to one another by a cross-member 44 in their upper end area. The two supports 38, 40 are pivotably supported in their lower areas by means of threaded bolts 46, 47 on the pivoting lock plates 28, 30 which define a first pivoting axis A₁.

The slot-like openings 32, 34 are penetrated by respective pivot lock bolts 48, 50 which furthermore engage in a threaded manner in the supports 38, 40. The supports 38, 40 are locked with respect to the pivoting lock plate 28, 30 and consequently with respect to the first mounting area 18 by turning the pivot lock bolts 48, 50 until tight. The slot-like arrangement enables a plurality of pivot positions to be selected here, which are limited by the range of angles between the respective end areas of the slot-like openings 32, 34. The pivot position of the second mounting area 36 shown in the figures with respect to the first mounting area 18, in which the second mounting area 36 stands essentially upright and its supports 38, 40 lie essentially parallel above the supports 20, 22 of the first mounting area 18, is a stowage pivot position of the second mounting area 36 to which further reference will be made below.

On their ends distant from the first mounting area 18 the supports 38, 40 of the second mounting area 36 bear respective attachment plates 52, 54 which are pivotable about a second pivoting axis A₂. One of these attachment plates, that is, in the diagram specifically the one on the left, can be unlocked to pivot about a swivel axis A₂ and/or locked to prevent pivoting by a pivot lock mechanism 56 actuated by a hand lever 58.

FIGS. 1, 4, 5 and 6 show that a monitor unit generally designated with 60 can be fixed to the two attachment plates 52, 54. For example, the attachment plates 52, 54 can be bolted to their lateral surfaces. Consequently, together with the attachment plates 52, 54 the monitor unit 60 is pivotable about the second pivoting axis A₂ and also able to be locked in various of these pivot positions by means of the pivot lock mechanism 56. The pivot position shown in the FIGS. 1, 4, 5 and 6 is a stowage pivot position, in which the monitor unit 60 is aligned with the supports 38, 40 of the second mounting area 36, that is, it lies approximately parallel to it and consequently also lies parallel above the supports 20, 22 of the first mounting area 18.

From the preceding description it is apparent that if the second mounting area 36 is in the stowage pivot position with respect to the first mounting area 18 and furthermore the monitor unit 60 is in the stowage pivot position with respect to the second mounting area 36, a station with an altogether very flat design is obtained, which essentially does not extend beyond the installation space taken by the floor plate 12.

The figures further show a manual control unit 62, by means of which an operator working with the workstation 10 can operate the various accessory units to be controlled. The manual control unit 62 includes a support arm 64, which includes two arm sections 66, 68 which are telescoping with respect to one another in their longitudinal direction. For example, a telescoping lock mechanism provided on the arm section 68 includes a spring-loaded locking bolt 72, which can engage in corresponding holes 74 in another arm section 66 and thus can lock these two arm sections 66, 68 and consequently the support arm 64 in a plurality of telescoping positions.

The arm section 66 of the support arm 64 is supported by a threaded bolt 76 on the support 22 of the first mounting area 18, said bolt defining a third pivoting axis A₃, such that said section is pivotable about the third pivoting axis A₃. It is apparent that all three pivoting axes A₁, A₂ and A₃ are essentially parallel to each other.

The manual control unit 62 is able to be locked with respect to the first mounting area 18 and/or the second mounting area 36 as well in a working pivot position shown in FIG. 2. In this working pivot position, locking takes place by the support arm 64 lying against a movement stop 78 borne on the support 22 as well as gravitational force. Here too, for example, an additional locking function could be achieved by a locking bolt. Fundamentally, however, the gravitational locking through secure resting on the movement stop 78 is sufficient and ensures very fast return pivoting into the securing pivot position shown in FIG. 3, in which the support arm 64 is essentially aligned parallel to the supports 22 and/or 40 of the first mounting area 18 and the second mounting area 36. In this stowage pivot position as well, the support arm 64 can be locked, as will be explained below.

An operating assembly 80 of the manual control unit 62 is supported on the arm section 68 of the support arm 64 such that it can pivot about a fourth pivoting axis A₄. This can defined by a threaded bolt 82 or suchlike supporting the operating assembly 80. The fourth pivoting axis A₄ is also parallel to the other swivel axes A₁ A₂ and A₃.

The operating assembly 80 is lockable in multiple pivot positions with respect to the arm section 68 and thus with respect to the support arm 64. A locking mechanism 81 is used for this, which can be released by a pushbutton 83, shown in FIG. 5, used for releasing the operating assembly 80. The pivot position shown in FIG. 2 is one of multiple possible working pivot positions in which a handle 84, provided for manipulating and accepting operating commands by an operator, stands essentially upright, that is, it extends approximately orthogonally with respect to the support arm 64. The pivot position seen in FIG. 3 and also in FIG. 4 is a stowage pivot position in which the operating assembly 80 is pivoted by approximately 90° with respect to the working pivot position, so that the handle 84 now lies approximately in extension of the support arm 64. In this stowage pivot position of the operating assembly 80, a stowage locking arrangement 86 provided on this can interact with a bolt-like counterpart 88 provided on the second mounting area to lock the operating assembly 80 with respect to the second mounting area 36 and consequently to lock the manual control unit 62 in the stowage lock position. However, it is necessary first to bring the second mounting area 36 into its stowage pivot position with respect to the first mounting area 18 as seen in the figures and bring the support arm 64 into its fully extended stowage telescoping position, for example. Thus it is ensured that the stowage locking arrangement 86 can interact with the bolt-like counterpart 88 so that the manual control unit 62 is reliably locked on the second mounting area 36. To do this it can furthermore be necessary to bring the monitor unit 60 into its stowage pivot position with respect to the second mounting area 36 so that in the stowage pivot position of the manual control unit 62 the operating assembly 80 (see FIG. 5), which covers areas of the monitor unit 60, does not interfere with the monitor unit 60 and/or damage it when the manual control unit 62 is pivoted upward.

The stowage locking arrangement 86 can, for example, be designed with a locking section not show in the figures, which in the stowage pivot position of the manual control unit 62 engages behind the bolt-like counterpart 88 and, for example, when the manual control unit is pivoted upward, arrives at the position engaging from behind the counterpart 88 by a deflecting bevel against spring tension. By pulling on a handle 90, this rear engagement can be released in order to bring the support arm 64 and/or the manual control unit 62 downward into the working pivot position. A similar mechanism can also be used to lock the operating assembly 80 in its two envisaged pivot positions with respect to the arm section 68 or to release the locking.

The present invention provides a workstation for integration in an aircraft, thus for example a helicopter, which fundamentally requires very little installation space with high flexibility for various assemblies. Nonetheless, the ability of the second mounting area to pivot with respect to the first mounting area provides the possibility to move the monitor unit more or less close to the seated operating position on a seat. The ability of the monitor unit to pivot with respect to the second mounting area then ensures that in various pivot positions of the second mounting area the operator can observe the monitor unit in an optimal manner in each case, even possibly dependent on the incidence of light. The telescoping ability of the support arm of the manual control unit further ensures ergonomic usability by different operators of varying size.

Since in the workstation according to the invention the two mounting areas with respect to each other, the monitor unit with respect to the second mounting area and the manual control unit with respect to the second mounting area in each case are lockable in a stowage pivot position, great safety is furthermore ensured for the operator for getting in and/or out, especially in case of an emergency. In this situation, the second mounting area is locked by friction with respect to the first mounting area, specifically by clamping of the pivoting lock plates on the respectively assigned supports. The monitor unit is also locked by a frictional clamping effect. The manual control unit is locked with respect to the second mounting area by positive fit, and the operating assembly is preferably also locked with respect to the support arm by positive fit. It is self-evident that where frictionally acting locking arrangements and/or mechanisms act in the embodiment shown, arrangements acting by positive fit can also be used.

It is self-evident that even further accessories or variations can be provided on the workstation 10 according to the invention. Thus, as shown in FIGS. 4 through 6, a lamp 92 can be provided, which is borne on a flexible support 94 and, for example, fixed on the second mounting area 36 so that, for example, during night operation the operator has sufficient light available. The monitor unit 60 can, for example, be constructed as a touch screen or/and be equipped with various buttons or keypads on its encompassing area, so that the operator can invoke and/or select various functions. The hand lever 84 of the operating assembly 80 can, of course, be fitted with various operating buttons, with which the operator can select various functions and/or operate a selected accessory unit in the desired form without having to let go of the hand lever 84.

In conclusion it is to be noted that, based on the fact that the workstation according to the invention is to be used in an aircraft, it is preferably constructed from very light building material, such as aluminium; where greater mechanical stresses are to be expected, steel parts or steel inserts or other high-strength building materials such as carbon fibre or glass fibre building materials or similar can be used.

1. A workstation for integration in an aircraft, in particular a helicopter, comprising:
a floor anchoring area (14) for anchoring the workstation (10) on an aircraft floor;
a first mounting area (18) which is essentially fixed on the floor anchoring area (14);
a second mounting area (36) which is supported on the first mounting area (18) such that it can pivot;
a monitor unit (60) which is mounted on the second mounting area (36) such that it can pivot;
a manual control unit (82) which is mounted on the first or the second mounting area (18, 36) such that it can pivot.

2. A workstation according to claim 1, characterized in that the second mounting area (36) is pivotable on the first mounting area (18) about a first pivoting axis (A₁) essentially parallel to the floor anchoring area (14).

3. A workstation according to claim 1 or 2, characterized in that the monitor unit (60) is pivotable on the second mounting area (36) about a second pivoting axis (A₂) essentially parallel to the floor anchoring area (14).

4. A workstation according to one of the claims 1 to 3, characterized in that the second mounting area (36) and the monitor unit (60) are pivotable about pivoting axes (A₁, A₂) essentially parallel to each other.

5. A workstation according to one of the claims 1 to 4, characterized in that the manual control unit (62) is pivotable on the first mounting area (18) about a third pivoting axis (A₃) essentially parallel to the floor anchoring area (14).

6. A workstation according to one of the claims 1 to 5, characterized in that the second mounting area (36) can be locked in a plurality of pivot positions with respect to the first mounting area (18).

7. A workstation according to claim 6, characterized in that the plurality of pivot positions includes a stowage pivot position for the second mounting area (36).

8. A workstation according to one of the claims 1 to 7, characterized in that the monitor unit (60) can be locked in a plurality of pivot positions with respect to the second mounting area (36).

9. A workstation according to claim 8, characterized in that the plurality of pivot positions includes a stowage pivot position for the monitor unit (60).

10. A workstation according to one of the claims 1 to 9, characterized in that the manual control unit (62) can be locked with respect to the first mounting area (18) in at least one working pivot position and a stowage pivot position.

11. A workstation according to claim 10, characterized in that a stowage locking arrangement (86) is assigned to the manual control unit (62), which locks it on the second mounting area (36) in the stowage pivot position of the manual control unit (62).

12. A workstation according to one of the claims 1 to 10, characterized in that the manual control unit (62) includes a telescoping support arm (64), which can be locked in a plurality of telescoping positions.

13. A workstation according to claim 12, characterized in that the plurality of telescoping positions includes a stowage telescoping position for the manual control unit (62).

14. A workstation according to one of the claims 1 to 13, characterized in that the manual control unit (62) includes an operating assembly (80) mounted on a support arm (64) such that it can pivot.

15. A workstation according to claim 14, characterized in that the operating assembly (80) is pivotable with respect to the support arm (64) about a fourth pivoting axis (A₄) essentially parallel to the floor anchoring area (14).

16. A workstation according to claim 14 or 15, characterized in that the operating assembly (80) can be positioned in a stowage pivot position and at least one working pivot position with respect to the support arm (64).

17. A workstation according to claim 7 and claim 11 and claim 13, characterized in that the manual control unit (62) can essentially only be locked on the second mounting area (36) with the second mounting area (36) arranged in the stowage pivot position and the manual control unit (62) arranged in the stowage telescoping position.

18. A workstation according to claim 16 and claim 17, characterized in that the manual control unit (62) can essentially only be locked on the second mounting area (36) with the operating assembly (80) positioned in the stowage pivot position with respect to the support arm (64).
